(19) United States
(12) Patent Application Publication
(10) Pub. No.: US 2003/0172177 A1
(43) Pub. Date: Sep. 11, 2003

(54) System and method for verifying a device

(76) Inventors: Ian P. Kersley, Bedford, MA (US); Joseph Sestrich, Acton, MA (US)

Correspondence Address: ROPES & GRAY LLP, ONE INTERNATIONAL PLACE, BOSTON, MA, 02110-2624, US

(21) Appl. No.: 10/016,172

(22) Filed: Dec. 6, 2001

(51) Int. Cl. G06F 15/16

(52) U.S. Cl. 709/236

(57) ABSTRACT

A system and method for verification of a device-under-test (DUT), in particular a network device, includes a library of packet descriptors that can be expanded to yield a packet byte stream for device testing. The packet descriptors are defined by a C-based test language, such as C/C++, and can be shared by various projects. Each packet descriptor has a unique identifier that allows retrieval of a specific packet descriptor from the library based on the identifier for comparison with the packets processed by the DUT and verification of the DUT. Packet descriptors can be arranged in the form of queues and flows supporting standard and custom network protocols. Flows can be merged and/or aggregated, allowing statistical evaluation of network traffic.

### FIELD OF THE INVENTION

The invention is directed to a system and method for testing electronic devices, and more particularly to verifying such devices with simulated network traffic by using a packet database.

### BACKGROUND OF THE INVENTION

Systems are known that simulate network traffic and verify devices on the hardware/system level by assembling the byte stream for the device under test (DUT) from application-specific and protocol-specific packets and headers. The DUT can be any device and/or system adapted to receive data input and supply data output, in particular devices and/or systems that process network traffic (e.g., switches, routers and the like). This approach requires that for each different hardware configuration and for each network transport protocol, new packet configurations are specified and assembled. This is a difficult task in systems that have millions of gates. Moreover, with large systems increasingly being assembled from preconfigured and pretested functional blocks (so-called IP), verifying the functionality of the larger system based on the test results obtained on the IP's adds significant complexity to the process.

Other known platform- and simulator-independent systems and methods, sometimes also referred to as “workbenches”, can be adapted for integration with VHDL and C functions and interact with a simulator through a unified system interface that supports multiple external types. A test generator module can automatically create verification tests from a functional description. The workbenches can manipulate complex data structures across several OSI layers, at different levels of abstraction, and interact at the frame or cell level. They can also generate large complex test sequences by using high-level commands and specify automatic analysis of output activity. None of these conventional systems, however, provides an integrated platform for creating complex, multi-protocol tests with standardized packet headers and data packets, including user-specific protocols.

It would therefore be desirable to provide a test system and method that is based on a high level, device-independent functional description language and is capable of efficiently and reproducibly simulating real time network traffic using a repertoire of packet data.

### SUMMARY OF THE INVENTION

The invention is directed to a system and method for generating packets to simulate complex network packet traffic patterns to test and verify a device under test (DUT). The packets can be built by selecting standard packet description headers and packet payloads from a packet database. Packets are reusable and can be built for all layers, including application layers, of a single project using one master packet building function and turned into a bit stream for the DUT.

According to one aspect of the invention, a method for verifying a device under test includes generating a packet descriptor, assigning a unique packet identifier to the packet descriptor, and generating a packet that corresponding to the packet descriptor. The packet is given the unique packet identifier of said packet descriptor. The packet is then transmitted to the device for processing by the device, and the processed packet is identified based on the unique packet identifier. The processed packet is compared with the generated packet having the same unique packet identifier to verify the device under test.

According to another aspect of the invention, a system for verification of a device under test includes a packet database with packet descriptors, wherein each packet descriptor has a unique packet identifier. The system further includes a transmit transactor that is coupled to the device and receives the packet descriptor. The transmit transactor builds from the packet descriptor a packet byte stream that is transmitted to the device for processing. A receive transactor receives from the device the processed byte stream and identifies the received packets based on the unique packet identifier. The system also includes a packet checker which compares the identified packet with a packet expanded from a corresponding packet descriptor in the packet database, which has the same unique packet identifier.

According to yet another aspect of the invention, a computer program product is provided for verifying a device under test. The computer program product includes computer executable code for generating a packet descriptor and assigning a unique packet identifier to the packet descriptor, and computer executable code for generating a packet corresponding to the packet descriptor, wherein the packet has the unique packet identifier of the packet descriptor. The computer program product further includes computer executable code for transmitting the packet to the device under test for processing by the device under test, for identifying the processed packet based on the unique packet identifier, and for comparing the processed packet with the generated packet having the same unique packet identifier to verify the device under test.

Embodiments of the invention may include one or more of the following features. The device under test (DUT) may be a network device, such as a switch or router. The packet descriptor can be generated by retrieving from a packet database a packet descriptor specified by a packet description language. In particular, a generalized packet descriptor adapted for a plurality of packet transmission protocols can be retrieved from a packet database, and only those elements from the generalized packet descriptor are retained in the packet descriptor that correspond to a desired packet transmission protocol. The unique packet identifier, which can be a frame sequence number, can be stored in a packet identifier database and retrieved from the packet database based on the unique packet identifier. The packet descriptors can be arranged in queue consisting of packet descriptors, wherein the packet descriptor queue is transmitted to the device. The packets processed by the DUT can be compared with the originally transmitted packet by obtaining a copy of the packet descriptor with unique packet identifier, expanding the copy into a regenerated packet, and comparing the processed packet with the regenerated packet. Alternatively, if the DUT is expected to modify the packets, the packets processed by the DUT can be compared with the originally transmitted packet by obtaining a copy of the packet descriptor with unique packet identifier, modifying the obtained copy of the packet descriptor, generating a regenerated packet from the modified copy, and comparing the processed packet with the regenerated packet.

According to another embodiment, a flow representing a transmission rate of the packet descriptors can be formed from a plurality of packet descriptors, wherein each flow has a unique flow identifier. Several flows can be combined into a port queue, which is transmitted to the DUT for processing. The flows can be combined by aggregation or merging. The flows processed by the DUT are de-multiplexed based on the unique flow identifier, before the processed packets are identified. The de-multiplexed flows can provide a flow statistics of the flows.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows schematically a design and verification system with a packet database;

FIG. 2 shows exemplary packet descriptors and associated packets;

FIG. 3 illustrates schematically a process for forming and verifying packets using the master building function of the invention.

FIG. 4 shows a detail of the packet verification process; and

FIG. 5 shows an example of flow aggregation.

### DETAILED DESCRIPTION OF CERTAIN ILLUSTRATED EMBODIMENTS

The invention is directed to a system and method for verifying a device under test (DUT) by simulating network traffic using a platform code that includes libraries, transport interfaces, files and other code that can be shared by several projects. In particular, the code and other resources can be reused. This is accomplished by generating in a high-level test environment, such as C/C++, a packet descriptor with a unique identifier and generating actual packets with the same identifier. A set of commonly used and/or custom packet descriptors can be predefined and stored in a packet database. Packets processed by the device are identified based on the unique identifier and compared with expanded packet descriptors with the same identifier. The term “Packet” is used to describe a unit of data at any layer of the OSI protocol stack.

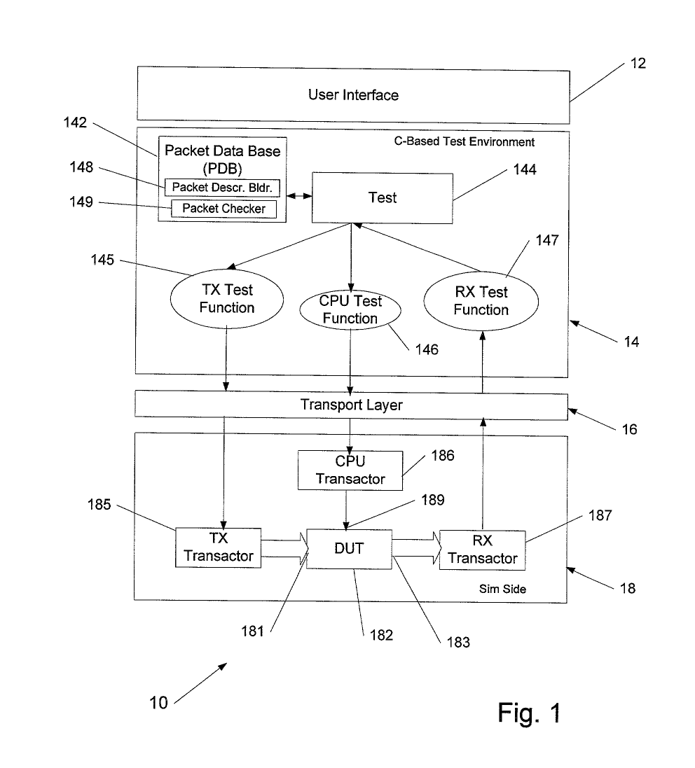

FIG. 1 shows the general structure of a project-based design and verification system 10. The system 10 includes a user interface 12, for example, a GUI, which allows a user to interact with a C-based test environment 14. The high-level user tests are typically written in C/C++ and linked to a set of libraries embedded in a test module 144. The test module 144 sets up the test environment and data, such as control commands in the C-based test environment 14 to control, for example, queues, ports, flows, and packets. A CPU test function module 146 translates the control commands into device-level commands that are transmitted to a CPU transactor 186 and the DUT 182.

The DUT 182 is the system being tested, which can also include external components such as memory and bus functional modules that act as a protocol converter to translate a block of data, passed down from the C-based test environment 14, into a format that can be accepted by the DUT TX port 181. Using the illustration in FIG. 1, it will be assumed for the following discussion that the exemplary DUT 182 represents a communications product. However, it should be understood that the present invention is not limited to communications products and can be used for verifying other devices and systems that transmit information in the form of bytes, cells and/or packets. The exemplary DUT 182 has a data entry port 181, a data exit port 183, and a host CPU port 189. Communications packet data can be sent from the data entry port 181 to the data exit port 183. The host CPU port 189 can access registers and perform housekeeping functions in the DUT 182 via the CPU port 189.

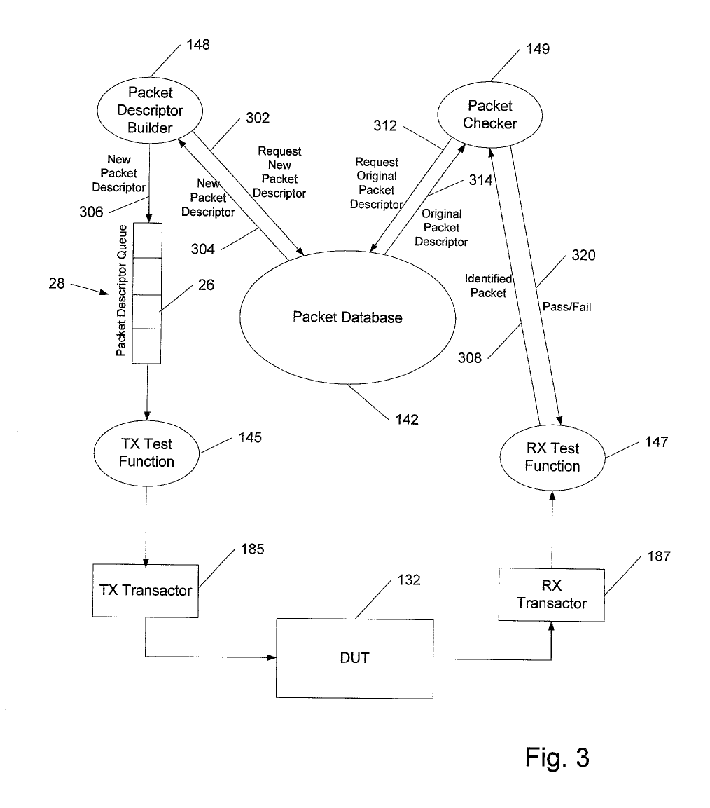

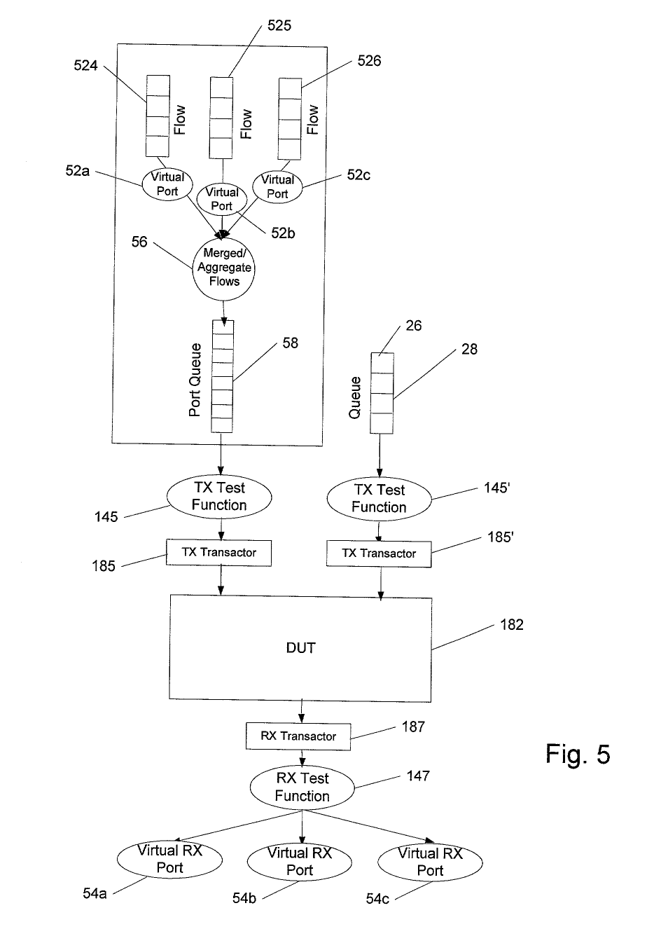

The exemplary test module 144 is linked to a packet database module (PDB) 142 which can include other modules, such as a packet descriptor builder 148 and a packet checker 149 which will be described in more detail below with reference to FIG. 3. The test module 144 can also include a flow manager (not shown) described below with reference to FIG. 5. Those skilled in the art will appreciate that the packet descriptor builder 148, the packet checker 149, the PDB 142 and/or the flow manager need not be separate units. The exemplary test module 144 allows tests to make high-level procedural calls to the DUT and can include additional libraries (not shown) containing routines to support various stages of the verification system development. This includes routines for error reporting, printing different types of debug messages, generating pseudo-random numbers, sorting and reordering data arrays, handling input and output databases, statistical evaluation, and simulation control.

As will be described in more detail with reference to FIG. 3, for simulating network traffic through the DUT 182, the C-based test environment 14 obtains packet descriptors from the PDB 142, with a TX (transmit) test function module 145 fetching the packet descriptors and converting the packet descriptors into a full packet and sending the packet to a TX transactor 185 for interfacing with the device under test (DUT) 182 on the simulation (Sim) side 18. The TX transactor 185 provides the data entry point for packet data to the DUT 182. The CPU transactor 186 interfaces to the DUT TX port protocol. A packet of data sent to the DUT 182 obeys any bus protocol defined for the DUT packet data bus.

A transport layer 16 is shown between the C-based test environment 14 and the Sim side 18. The transport layer 16 allows data to be transferred between the C-based test environment 14 and the RTL (Register Transfer Language)-based Sim side 18. The Sim side 18 interfaces to the transport layer 16 through a HDL programming language interface (PLI) calls, made within each transactor instance by the transport layer interface tasks. The PLI routines establish an area of shared system memory with the C test process to allow data to be moved in and out of this region by either the C or the simulation process.

In the C test process, the transport layer provides a means of alerting the test process to any pending data or requests from the simulation. In addition, it provides the entry retrieval mechanism for the test functions to access data within the shared memory. The transport layer 16 is linked into the test program as a precompiled library and a header file to define the available functions. An exemplary transport layer 16 is the TestBenchPlus™ interface commercially available from Zaiq Inc, Woburn, Mass. The transport layer 16 software supports the:

ability to create/add any type of interface for data transfer;

repeatability of hardware simulations;

scalability and mobility of the verification system;

migration from unit to system verification, providing high levels of controllability and observability.

The output side 183 of the DUT 182 on the Sim side 18 is connected to a RX (receive) transactor 187, which provides the data exit point for packet data from the DUT 182. The transport layer 16 then transfer the data up to the associated C test function 147. A RX test function 147 receives the transmitted packet byte stream from the RX transactor 187. The RX test function 147 and the RX transactor 187, like the TX test function 145 and the TX transactor 185, exist on a thread. In a test, the test function module 144 in FIG. 1 initiates the creation of threads and assigns a one-to-one mapping between a transactor 185 and its associated test function 145. It also specifies which threads have to complete before the test itself is deemed to have completed. One or more test functions can drive one or more transactor instances on the Sim side 18.

The aforedescribed test functions 145, 146, 147 are blocks of C code that are associated with a given transactor instance within the simulation. When a transactor in the simulation has no operation to process, it makes a request for a new instruction through the transport layer 16. When the request is received, the environment switches the execution context to the test function attached to that particular transactor. The test function then executes until it encounters a call to the simulation. In the case of a function attached to a CPU transactor 186, this call could be a write or read command to a certain address in the simulation. In the case of a function attached to a TX transactor 185 or a RX transactor 187, this call could be to send or receive a new packet of data. In either case, the test function prepares the instruction for the transactor to execute, as well as any associated data (e.g., write data or transmit packet).

Once the new instruction is prepared, the respective test function hands the instruction to the transport layer 16, and the environment suspends execution of the test function, switching context back to the main code thread. The transport layer 16 then passes the instruction down to the simulation, and thus to the transactor that made the initial request for service.

The TX test function 145 is mapped to the TX transactor 185 instance within the simulation. When the transactor 185 requests another packet to send into the simulation, the TX test function 145 executes until it has generated a new packet of data to be injected into the DUT 182. The data packet is then moved into the shared memory of the transport layer 16, and the TX test function 145 is suspended until the TX transactor 185 makes a subsequent call.

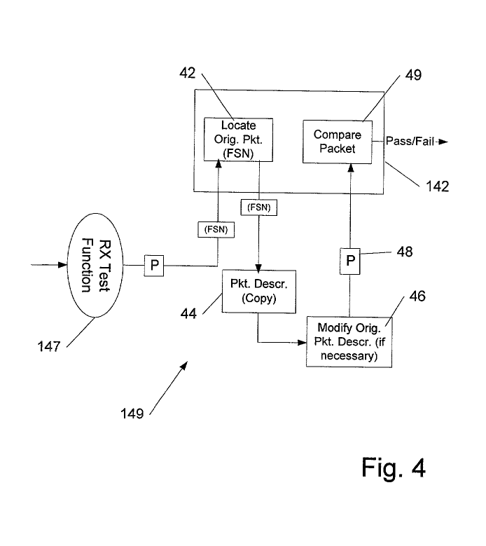

The RX test function 147 is mapped to the RX transactor 187 instance within the simulation. When the transactor 187 receives a packet from the simulation, the RX test function executes to retrieve the packet from the shared memory of the transport layer 16. The RX function 147 verifies that the packet is correct (see the discussion below with reference to FIGS. 3 and 4), and is then suspended until the RX transactor 187 makes a subsequent call.

The CPU test function 146-is a C function that is mapped to the CPU transactor 186 within the simulation. When the CPU transactor 146 requires a new instruction to execute, it passes a request to the C code through the transport layer 16. The CPU test function 146 then executes until it encounters a call to the simulation (in the form of a write or read operation to perform on the DUT host bus). The details of the transaction are written into the shared memory of the transport layer 16, whereafter the CPU test function 146 is suspended.

As mentioned above with reference to FIG. 1, the packet database 142 in the C-based test environment 14 produces packet descriptors which are translated into the actual packets by the TX test function 145. New packet descriptors are created by a dedicated function that also assigns a unique packet identifier, or frame sequence number (FSN), to the new descriptor. The FSNs for all created descriptors can be held on a FSN database such that, once the descriptor is created, a pointer to that descriptor can be recovered at any time, by any test function, simply by supplying the FSN of the descriptor to the FSN database. These descriptors specify a packet as a number of sub-elements, or headers, which also include a packet payload, or PDU.

The other headers specified by the packet descriptor can be thought of as encapsulations that are prepended or appended to the PDU. The definition of a packet consists of marking headers as enabled or disabled, which determines whether the header will appear as part of the corresponding packet.

If a header is to be enabled, the fields in that header should also be defined. For example, if a packet is to represent an Ethernet frame, the Ethernet header would be enabled, and the header fields of the Ethernet header would have to be defined. Once a packet descriptor has been defined, it is placed onto a queue for transmission. The queue on which it is placed should be the local transmit queue of the test function attached to the transactor that will inject the packet.

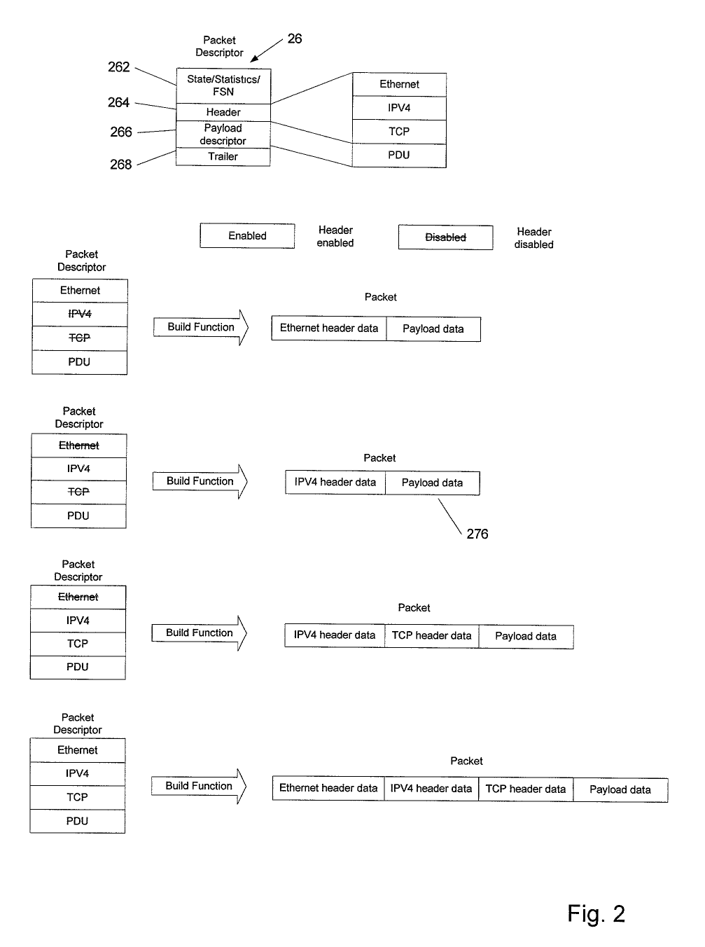

Referring now also to FIG. 2, a packet descriptor 26 typically specifies a packet as a number of sub-elements followed by a packet descriptor unit (PDU) 266 representing the payload data. One of the sub-elements 262 typically includes state and statistics information and at least the unique frame sequence number (FSN), which is also associated with the actual packet and allows an unambiguous correlation between the (high-level) packet descriptors 26 and the packets (bytes) themselves. The FSN can hence be used to locate the original packet descriptor as well as the associated packet.

State information 262 may also include timing information, such as the start and end of transmission, number of copies for multicasting, the source and destination of the packet, and how many copies of the packet exist within the system under test. This information can be provided to the user with all the packet descriptors.

Header 264 is related to the network protocol used by the packets transmitted to the DUT 182. The packet header 264 can vary from system to system and from project to project. However, the user can be provided with a library of commonly employed headers, such as Ethernet headers, IPV4 headers, and DSL headers, as well as with optional custom headers (not shown). A function build_packet_header provides the packet descriptors 26 with suitable standard and/or custom headers 264 that are then built into the byte stream to be transmitted via the generating transactor 185 to the DUT 182.

Likewise, packet trailers 268 of packet descriptors 26 can vary from system to system and from project to project. Packet trailer can be generated in a similar manner as packet headers, except that their normal position within a packet byte stream is after the PDU field.

The basic structure of a packet descriptor is illustrated in FIG. 2. These descriptors can be project-specific, since different projects may be dealing with different packet types. For example, a basic L2 switch may only need to know about Ethernet packet protocol, whereas a more complex L3 router might need to be aware of multiple protocols such as IP, TCP, etc. However, despite the differences in content, a common overall architecture of a packet descriptor can be maintained. An exemplary packet descriptor consisting of a C data structure with multiple protocol headers may look as follows:

typedef struct {

ENET_HDR_T enet;
IPV4_HDR_T ipv4;
TCP_HDR_T tcp;
PDU_HDR_T pdu;
FSN_HDR_T fsn;
STATS_HDR_T stats;
STATE_HDR_T state;

} PROJ_PKT_T;

As also shown in FIG. 2, certain fields can be enabled and disabled, respectively, in the packet descriptor headers, which determines whether or not a given header is added to the current packet byte stream by the header build function. All the packet formats of FIG. 2 as well as additional custom formats can be generated from the exemplary descriptor. For example, for a verification test suite for a layer2/layer3 switch/router design, the tests have to be able to generate packets that have some combination of Ethernet, Ipv4, and TCP encapsulation as well as an arbitrary length payload (PDU). This is possible due to the mechanism used to translate a packet descriptor into a full packet, or byte array, that is to be injected into the simulation. This conversion is performed in the following manner. Each packet descriptor element, such as the Ethernet header (ENET_HDR_T), has an associated header builder function. This function is responsible for converting the field definitions in the header into a contiguous byte stream that can then be appended to a packet byte stream under construction. A DUT verification project defines a master packet builder function (see FIG. 3), which calls all of the individual header builder functions in a defined order. If a particular header has its enable field set, the header will be constructed by the header builder and appended to the packet under construction. If the header enable flag is not set, the header builder function will do nothing, and will simply return without appending any bytes to the packet under construction. It will be understood that depending on the protocol, this structure, although referred to as a header, can also be a packet trailer, i.e., its normal position within a packet byte stream is after the PDU field.

A master packet builder function for the exemplary packet with Ethernet, IPV4 and TCP headers enabled would appear as follows:

u_int32 BuildPacket(PROJ_PKT_T * pkt_descriptor,
u_int8 * pkt_ptr) { u_int32 length = 0;
if(pkt_descriptor!=NULL) {
length += PLAT_BuildEnetHdr(&pkt_descriptor−>enet, &pkt_ptr);
length += PLAT_BuildIpV4Hdr(&pkt_descriptor−>ipv4, &pkt_ptr);
length += PLAT_BuildTcpHdr(&pkt_descriptor−>tcp, &pkt_ptr);
length += PLAT_BuildPduHdr(&pkt_descriptor−>pdu, &pkt_ptr);
length += PLAT_BuildFsnHdr(&pkt_descriptor−>fsn, &pkt_ptr);
}

return(length);

}

Note that the individual header builder functions are given a pointer to the pkt_ptr variable, which allows the individual header builder functions to advance the pkt_ptr index by the number of bytes that the build function is adding to the packet.

The exemplary BuildPacket( ) function includes a header builder function for the FSN header. The FSN will typically be embedded into the packet byte stream at a location that the packet receiver code knows about. This allows the packet receiver function to receive a complete packet from the simulation, extract the FSN from the received packet, and obtain a copy of the originating packet descriptor. The original descriptor can then be used to re-create the packet that was injected into the simulation, which in turn can be compared against the received packet to ensure that the packet has not been corrupted as it passed through the simulation.

The BuildPacket( ) function can generate all of the packet formats shown in FIG. 2, depending on the state of the enable flags in each header. An exemplary enabled Ethernet header has the following structure:

typedef struct {

u_int64 sa : 48;
u_int64 da : 48;
u_int16 typelength;
VLAN_HDR_T vlan;
u_int32 enable : 1;

} ENET_HDR_T;

Once a packet descriptor has been defined, it is placed onto a queue 28 for transmission. The queue on which it is placed should be the local transmit queue of the test function 145 attached to the transactor 185 that will inject the packet. A packet descriptor that resides on the queue will remain on the queue until the queue fills up. Queues allow the test writer to pre-define multiple packets for each TX transactor 185 instance. This allows the TX transactor 185 to be very simplistic, simply reading the packets from the queue and building the packet for transmission through the system. The RX transactors 187 also use the queue mechanism to identify the source of a received packet.

The payload data 276 built from the payload description unit (PDU) 266 in the packet descriptor 26 is the data that needs to be transmitted through the DUT 182. The user has the option to specify the type of payload and how to generate it, for example, from payload data stored in the packet database 142, or to explicitly assign the payload. A function Build_payload then builds the payload into the byte stream.

The packet descriptor structure can include additional headers useful for statistical analysis and state information. These headers are not shown separately in the drawings. A statistics header is provided to allow the platform to track the simulation times at which a packet:

Starts to be transmitted by a transactor

Has been completely transmitted by a transactor

Has started to be received by a transactor

Has been completely received by a transactor.

These times are automatically updated on a per-packet basis by the platform packet send and receive functions. The fields in the statistics header are shown below.

A state header allows the specification of information such as originating port id, allowable destination ports, and multicast copy counts.

Other headers specified by the packet descriptor can be thought of as encapsulations that are prepended or appended to the PDU. A packet can be defined by marking headers as enabled or disabled, which determines whether the header will appear as part of the corresponding packet. This is illustrated in FIG. 2.

The packet database 142 manages the creation of packet descriptor queues and individual packet descriptors. It also provides functionality to tag packets (adding or inserting the FSN) and to retrieve a packet descriptor, based on a received FSN. With the packet database 142, the test writer obtains a “toolbox” of packet generation, validation and management functions that become part of the PREP (Preconfigured Reusable Environment and Platform) code base of the invention. The packet database functions are sufficiently generic and extensible to satisfy diverse project needs.

The FSN database mentioned above is responsible for maintaining a table to provide for the correlation of a given FSN to a given packet descriptor. Each time a new descriptor is created, a unique FSN is generated for that descriptor. This FSN is stored in a table, maintained by the FSN database, that also contains a pointer to the associated packet descriptor.

When the packet that was built from that descriptor is received by a transactor function, the RX test function 147 can extract the FSN from the packet and query the FSN database. The database will search its table for the FSN and its corresponding packet descriptor pointer. The pointer to the descriptor can then be passed back to the RX test function 147, which can use the original packet descriptor to re-create the original packet for comparison against the received data.

FIG. 3 is a schematic diagram describing the generation and verification of packet descriptors and packets. A user requests from the packet database 142 a new packet descriptor, step 302, which is returned to the packet descriptor builder 148 in step 304. As mentioned above, the packet database 142 manages the creation of packet descriptor queues and individual packet descriptors. A packet description language (PDL) allows test writers to specify quickly the numbers and types of packets to be injected into a simulation from a given transactor. The PDL interprets specific file types (.pdl files). The operation of the PDL will now be briefly described.

For example, a user wants to generate 20 packets to inject into the simulation. These packets are to have an Ethernet encapsulation and an incrementing data pattern as the payload. The packets are to increase in length by one byte every packet, such that packet 1 has a payload of 64 bytes and packet 20 has a payload of 84 bytes. The Ethernet da (destination address) and sa (source address) header fields will remain constant for all packets in this example, but the length field has to reflect the incrementing payload length. In addition, there will be a fixed spacing of 20 clock cycles between the packets. This spacing can be specified in the .ipg variable in the statistics header (stats). The stats.ipg value can also be assigned as a range, random, incrementing, etc. Users can specify the value of any packet header field in the PDL file. Unspecified fields will default to 0. The exemplary .pdl file to generate this packet stream is as follows:

list = sequence1 {

pkt_count = 20;
enet.enable = HEADER_ENABLED;
enet.sa = 0x123456789abc;
enet.da = 0xfeedface33;
enet.typelength = INC[64];
pdu.enable = HEADER_ENABLED;
pdu.pattern = INC_BYTE [0x01020304];
pdu.length = INC[64];
stats.ipg = 20;

}

The packet database 142 includes standard and/or custom headers, optional trailers as well as predefined payload data. The new packet descriptor and the corresponding packet are assigned a common unique FSN to allow subsequent identification and association of packet descriptors and packets for verification. The packet descriptor builder 148 is a dedicated, user-defined function that defines packet descriptors 26 and places them onto a particular packet descriptor queue 28. This function can be project- and test-specific. The function may also be replaced by a packet description language file. The packet descriptor queue 28 is a list of packet descriptors 26 that are subsequently expanded into full packets and sent to the simulation for insertion into the DUT 182. The packet descriptor queue is created and managed by the packet database 142. Packet descriptors 26 can be added to the packet descriptor queue 28 by an external function (e.g., the packet descriptor builder 148), and can be read from it for expansion into full packets by other functions, such as the TX test function 145 and the packet checker function 149.

An exemplary packet descriptor queue “queuel” showing the description of the packets that exist on any TX queue using the packet sequence reads as follows:

list = queue1 {

pkt_count = SELF_CALCULATING;
enet.enable = HEADER_ENABLED;
enet.sa = 0x123456789abc;
enet.da = WALKING_ONE[0x000001];
pdu.enable = HEADER_ENABLED;
pdu.pattern = INC_BYTE [0x01020304];
pdu.length = INC[48:128];

}

The keyword “list” indicates the start of a packet description structure. This structure contains certain mandatory elements, as well as a number of optional fields. The example defines the list name as “queue1”. This mandatory field uniquely identifies the following packet descriptions, such that a mapping can be created between a queue containing this particular list of packet descriptors, and a transmit queue reference. Multiple transactor queue references can be assigned to the same list reference, as each queue instance is unique. For example, if two transactors were assigned to use “queue1”, two copies of the descriptor sequence described by list “queue1” would be created, one for each transactor queue.

The mandatory field pkt₁₃count specifies the number of packets to be sent. There are no restrictions on this field which can be project-specific. In the above example, the field is set to SELF_CALCULATING. The maximum range defined is [48:128], meaning that the packet count will be set to 80 (128−48). The Ethernet source address (enet.sa) is being defined to a fixed value for all packets in this queue. The destination address (enet.da) is to be generated as a “walking-one” pattern, starting with the hex value 0×000000001. 4.4.7.4 The field pdu.pattern is mandatory if the PDU header is present. This field specifies the data pattern used within the packet payload. The mandatory field pdu.length is also mandatory if the PDU header is present. This field specifies the size of the packet payload in bytes. In the above example, the payload size increments between 48 bytes and 128 bytes, such that each packet has a pdu length one greater than the previous packet. Once the upper limit of 128 bytes is reached, the next packet will have a pdu length reset back to 48 bytes, and the sequence repeats.

As seen in FIG. 3, the sequence of packet descriptors 26 is assembled into a packet descriptor queue 28, such as the exemplary queue “queue 1” described above, step 306, and transmitted to the TX test function module 145 which converts the packet descriptor queue 28 into a byte stream, which is then transmitted to the TX transactor 185 and further to the DUT 182 for processing by the DUT 182.

The processed byte stream is received by the RX transactor 187 and optionally stripped of extraneous protocol information. The (stripped) processed byte stream is then sent as packet data or cells (depending on the protocol) to the RX test function module 147, where the packets are identified by the FSN and extracted. The identified packets are then forwarded to the packet checker 149, step 308. The packet checker 149 verifies the content of a received packet by comparing it against the transmitted original or a copy thereof. The packet checker 149 searches the received packet to extract the FSN, and then passes the FSN up to the packet database or the aforementioned FSN database, step 312. The packet database or FSN database 142 can then identify the original packet descriptor from which the transmitted packet was built, and can return a copy of that descriptor to the RX test function 147. The receiving test function can then call the packet build function to regenerate the original full packet. It can then compare the received packet with the original packet and determine the validity of the received packet by generating a “Pass” or “Fail” message, step 320.

As seen from the discussion above, the packet database 142 performs the following primary functions:

The packet database is responsible for the creation of packet descriptors, which are groups of data structures that can be expanded to create a full packet.

The packet database maintains a database of packet identifiers, or frame sequence numbers (FSN). These packet identifiers enable a function, receiving a packet from the simulation, to identify the original packet that was injected into the simulation.

The packet database creates and maintains packet descriptor queues, which are responsible for the creation and sequencing of multiple packet descriptors for transmission into the simulation. In addition, the queues can provide information about received packets.

If the DUT is expected to have modified a packet, such that a packet header contains different information in one or more fields, or has been removed altogether, the packet checker 149 should be able predict the content of the received packet. This can be done by one or both of the following routines depicted in FIG. 4:

On one hand, the expected packet can be modified in the RX test function 147 before the RX test function 147 regenerates an expected packet from the original descriptor. When the expected packet is regenerated from this modified original descriptor, it should reflect the result expected from the packet having passed through the DUT. It can then be compared with the received packet to ensure that the DUT performed the modification correctly.

On the other hand, the expected packet can modified in the RX test function 147 after the packet checker 149 has regenerated the expected packet from the original descriptor, but before it compares the regenerated packet to the received packet. If the DUT is expected to have modified bytes in the packet payload (PDU), the RX test function 147 ought to be able to predict these modifications and apply them to the regenerated original packet prior to comparing it with the received packet. This modification has to be done after the original packet has been regenerated, since this is the time at which the original PDU data exists in the RX test function 147.

As seen in FIG. 4, the packet database 142 locates the original packet based on the FSN (42) and retrieves a copy of the original packet descriptor (44). If necessary, the particular header within the original descriptor can have the appropriate fields modified or replaced with the expected values by a separate function 46 called from within the packet checker 149, or the whole header can be disabled. The expected packet is regenerated from this modified original descriptor can then be compared with the received packet to ensure that the DUT performed the modification correctly.

In summary, the PDB/packet checker 149 performs the following comparisons:

Did the packet reach the correct transactor?

Did the expected number of packets arrive?

Did the packet arrive in the correct order relative to other expected packets?

Did the expected packet match the received packet byte for byte?

Did the packet split into multiple cells?

If the received packet successfully passes the above comparisons, then the packet is recorded as a successful transmission. However, if any of the above comparisons fail, then an error is recorded for future reporting purposes and statistical evaluation.

Another aspect of the invention relates to a flow management process illustrated in FIG. 5. The flow management process which can be part of the packet database (PDB) 142 is responsible for the creation and maintenance of virtual flows of traffic through a DUT 182. A flow consists of a queue and an associated data structure to define certain traffic flow characteristics that apply to any packets entering the simulation that originate from that queue, e.g. transmission bit-rate.

The flow manager allows test writers to specify the characteristics for a given packet stream, or flow, being sent through the simulation. This characteristics includes defining a transmission data rate, an allowable drop rate, and other relevant information to describe the traffic sequence. Once these characteristics are defined, the flow manager can then monitor traffic passing through the DUT and identify packets that are allocated to the given flow. When a packet traveling on a given flow is received from the simulation, the statistics associated with that flow can be updated. If a flow deviates from the allowable characteristics, the flow manager can signal this, typically as an error.

The flow manager also provides functionality for merging or aggregating of multiple individual flows for injection through a single transactor. This capability allows for the simulation of a communications device receiving traffic from different sources, each source potentially having a different traffic profile. A traffic source or destination in this system is referred to as a virtual port. A flow is established between one virtual TX port and one (or more) other virtual RX ports.

The TX transactors in this system become physical transmit ports, or data entry points. Multiple virtual flows can be aggregated onto a single physical TX port in order to enter a simulation. In the same way, an RX transactor also acts as a physical RX port. The RX port can receive packets on multiple virtual flows, and is responsible for “de-multiplexing” the packets and for passing them up to the appropriate virtual RX port to allow the statistics for that particular flow to be updated.

Referring now to FIG. 5, flows 524, 525, 526 can flow through respective virtual TX ports 52a, 52b, 52c to any virtual RX port 54a, 54b, 54c. The number of the TX ports and the RX ports need not be identical. The packet descriptor flows 524, 525, 526 from the various virtual TX ports 52a, 52b, 52c are aggregated/merged at point 56 onto a single port queue 58 and transmitted to TX test function 145, where a corresponding byte stream is created in the manner described above. The byte stream representative of the aggregated packet descriptor flows 524, 525, 526 enters the simulation via the TX transactor 185 (TX port). The packets will then exit the simulation through the RX transactor 187 (RX port) and be processed by the RX test function 147. This function will pass the packets, retrieved as part of the packet check process to the flow manager for distribution to the virtual RX ports 54a, 54b, 54c designated by the Flow ID.

Flows 524, 525, 526 can either be aggregated or merged at point 56 into port queues 247, whereby packets may be transmitted into a single data stream or queue at different rates. The net effect of a port is to allow the verification designer to model different traffic patterns and burst rates. In a merging operation, several flows are combined based on a specified ratio (2:1, 10:1, . . . ). Conversely, in an aggregation operation, flows are combined based on the flow and port rates, thereby never exceeding an allowable port rate. All ports have a port identifier that controls and validates packet source and destination points.

As also seen in FIG. 5, other byte streams can enter the DUT 182 together with the aforedescribed flows, optionally through additional TX transactors 185′.

When packets are received by the RX test function 147, the RX test function 147 is expected to verify the integrity of each received packet. In a flow-based testing situation, the packet RX function should also pass the received packet descriptors up to the flow manager flow monitor. The flow monitor will examine the packet descriptor statistics header to determine which flow the packet was traveling over as it passed through the simulation. The statistics header also contains the simulation times at which the packet entered and exited the simulation. Using this information, together with the packet byte count, the flow monitor can update the statistics for the given flow and determine whether the specified parameters for the flow, such as required minimum data rate, are being maintained correctly.

To illustrate the use of the packet database, the following three pseudo-code examples are provided for: 1) a Basic Example Test; 2) a PDL Example Test; and 3) Flow Manager Code.

The Basic Example Test is the top-level test code. There are three transactors present: a CPU, a packet transmitter (TX), and a packet receiver (RX). For the purposes of this example, it will be assumed that the DUT does not modify the packets as it passes them from the TX transactor bus to the RX transactor bus. The test is going to set up the DUT with the CPU transactor, and then inject a packet sequence from the TX transactor, and receive and check the packets at the RX transactor.

The packet descriptors that define the packet sequence will be created before the CPU initializes the DUT. This will be done by a test-level local function, build_descriptor_list( ).

Example_test( ) {
/* Attach test functions to their respective transactors */
PLAT_SetupThreadFunction(CPU_TRANSACTOR1, cpu_func, 0);
PLAT_SetupThreadFunction(TX_TRANSACTOR1, TX_DefaultFrameSm, 0);
PLAT_SetupThreadFunction(RX_TRANSACTOR1, RX_DefaultFrameSm, 0);
/*
* Call a local function to build the transmit descriptors and place them on the
* transmit descriptor queue of the TX_TRANSACTOR1 test function
*/
build_descriptor_list(TX_TRANSACTOR1);
/* Wait for the TEST_COMPLETE signal to be asserted or for 1000000 time units to
elapse */
PLAT_WaitTest(TEST_COMPLETE, 1000000);
}

The PLAT_SetupThreadFunction( ) creates a thread for the specified test function, and associates that thread with the given transactor identifier. It also creates any required thread-specific data structures, such as the default TX and RX queues.

The build_descriptor_list(queue_name) function illustrates how any test function can build packet descriptors, specify the descriptor contents, and then place those descriptors onto any named queue to be processed. The result of this function is a static list of packet descriptors that can be transmitted into a DUT by another function.

build_desciptor_list(TRANS_HANDLE_T transactor_name) {

PROJ_PKT_T * new_descriptor;
for(number_packets_to_build) {

new_descriptor = PROJ_CreateDescriptor( );
fill_in_descriptor_fields( );

PLAT_AddToTxQueue(transactor_name, new_descriptor);

}

The PLAT_WaitTest(event, timeout) function is used to define when the test should be deemed complete by the environment control code. The test runs until either the test times out (i.e., the event control detects that the number of simulation clocks specified by the timeout value has elapsed) or the signal specified by event has been asserted.

The cpu_func( ) routine executes on the CPU_TRANSACTOR1 transactor. It allows the cpu routine to control the operation of the packet generator and receiver functions. The routine can set a flag that will terminate the overall test routine and can have the cpu function determine how many packets have been received by RX_TRANSACTOR1 at any time by reading the per-thread data structure of RX_TRANSACTOR1.

The PDL (Packet Description Language) Example Test allows a test writer to assign transactor instances, test functions, and PDL lists. An exemplary test routine is listed below:

void example( ) {

u_int32 dsc_count;
/*
* Read a PDL file
*/
PLAT_BuildPdlParamTable(“test.pdl”);
/*
* Attach transactors to their respective test functions
*/
PLAT_SetupThreadFunction(CPU_TRANSACTOR_0, proc_func, 0);
PLAT_SetupThreadFunction(TX_TRANSACTOR_0, TX_DefaultFrameSm, 0);
PLAT_SetupThreadFunction(RX_TRANSACTOR_0, RX_DefaultFrameSm, 0);
/*
* Define a local function to modify received packet descriptors
* to predict the expected value - This does nothing yet
*/
PLAT_SetRxDscModFunc(RX_TRANSACTOR_0, my_dsc_mod_func);
/*
* Build 2 PDL_based descriptor lists. The first sets up 1 segmented packet.
* The second sets up 4 non-segmented packets.
* these are set like this to tie-up with the expected command
* sequence to the transactor, issued from the proc_func( ).
*/
dsc_count = PROJ_BuildPdlDescriptorList(TX_TRANSACTOR_0, “tx_list1”);
dsc_count = PROJ_BuildPdlDescriptorList(TX_TRANSACTOR_0, “tx_list2”);
/*
* Wait for the assertion of the TEST_COMPLETE signal,
* or for > 1000000 time units to elapse
*/
PLAT_WaitTest( TEST_COMPLETE,1000000);

}

The PLAT_BuildPdlParamTable(function is contained in the platform code PDL module. The function scans through a .pdl file and extracts any list entries that it finds in the .pdl file. The list entries and all of their associated header field definitions are extracted from the .pdl file into a C data structure. This structure can then be referenced by other C functions to extract the data field values.

The PLAT SetupThreadFunction( ) function makes the association between a test function and a transactor instance. In the above example, the test function proc_funco executes against the CPU transactor, the TX_DefaultFrameSm( ) function executes on the TX transactor, and the RX_DefaultFrameSm( ) function executes on the RX transactor. The TX_DefaultFrameSm( ) and RX_DefaultFrameSm( ) functions are generic functions for transmitting and receiving packets, respectively.

The PLAT_SetRxDscModFunc( ) allows definition of the RX callback function (see FIG. 4) to modify the recovered originating packet descriptor, prior to the build and comparison process in the receive packet flow.

The PROJ_BuildPdlDescriptorList( ) function is given a transactor handle and a PDL list name, and then locates the list name within the data structure created by the PLAT_BuildPdlParamTable( ) function described above. If the list name is not found on the structure, an error is generated and the test is aborted. If the list is found on the data structure, the function will build the number of packet descriptors specified in the PDL list.

The corresponding PDL file, test.pdl, is shown below.

# PDL test file
list = tx_list1 {

pkt_count = 1;

# ATM cell header - note this is not enabled

cellhdr.gfc = 0;
cellhdr.vp = 0x11;
cellhdr.vc = 0xfade;
cellhdr.pt = 0;
cellhdr.clp = 0;
cellhdr.enable = HEADER_DISABLED;

# project-specific frame carrier header, needed if segmenting

frmhdr.enable = HEADER_DISABLED;
frmhdr.frame_tag = 0xeeff;
frmhdr.pdu_len = INC[64];

# AAL5 frame trailer, needed if segmenting

aal5.enable = HEADER_ENABLED;
aal5.badcrc = 0;

aal5.uu = 0x12;

aal5.cpi = 0xef;
aal5.len = INC[64];
aal5.crc32 = 0;

# pdu stuff

pdu.enable = HEADER_ENABLED;
pdu.length = INC[64];
pdu.seed = 0x01020304;
pdu.pattern = INC_BYTE;

# fsn

fsn.position = FSN_DEFAULT;

}
list = tx_list2 {

pkt_count = SELF_CALCULATING;

# ethernet hdr

enet.enable = HEADER_ENABLED;
enet.sa = 0x112233445566;
enet.typelength = INC[68:72];
vlan.enable = HEADER_DISABLED;

# pdu stuff

pdu.enable = HEADER_ENABLED;
pdu.length = INC[68:72];
pdu.seed = 0x02030405;
pdu.pattern = INC_BYTE;

# fsn

fsn.position = FSN_DEFAULT;

}

The Flow Manager Example Code illustrates the use of the flow manager within a test. The various functions used in the code have been described above.

flow_test( ) {

u_int32 port_data_rate;
PDB_FLOW_T * flow_ptr;
/*
* Attach transactors to their respective test functions
*/
PLAT_SetupThreadFunction(CPU_TRANSACTOR_0, proc_func, 0);
PLAT_SetupThreadFunction(TX_TRANSACTOR_0, TX_DefaultFrameSm, 0);
PLAT_SetupThreadFunction(RX_TRANSACTOR_0, RX_DefaultFrameSm, 0);
/*
* Create a port and associate it with TX_TRANSACTOR_0.
* The port is assigned a data rate of 1000Mb/s
*/
port_data_rate = 1000;
PLAT_CreatePort(TX_TRANSACTOR_0, port_data_rate);
/*
* Create two virtual flows, assign a data rate to each,
* and associate them with the port for TX_TRANSACTOR_0
*/
flow_ptr = PLAT_CreateFlow(FLOW1);
flow_ptr−>data_rate = 400;
PLAT_AddFlowToPort(FLOW1,TX_TRANSACTOR_0);
flow_ptr = PLAT_CreateFlow(FLOW2);
flow_ptr−>data_rate = 200;
PLAT_AddFlowToPort(FLOW2,TX_TRANSACTOR_0);
/*
* Read in packet sequences from a PDL file to
* generate the descriptor lists for the two flows.
*/
PLAT_BuildPdlParamTable(“flow_test.pdl”);
MSG_Milestone(“Assigning %d descriptors to flow 1\n”,
PROJ_BuildPdlDescriptorList(FLOW1, “list1”));
MSG_Milestone(“Assigning %d descriptors to flow 2\n”,
PROJ_BuildPdlDescriptorList(FLOW2, “list2”));
/*
* Aggregate the flows on the port associated with TX_TRANSACTOR_0
* to produce a single packet sequence for transmission by the transactor
*/
PROJ_AggregatePortFlows(TX_TRANSACTOR_0);
/*
* Wait for the signal TEST_COMPLETE to be asserted,
* or for > 10000 time units to elapse
*/
PLAT_WaitTest(TEST_COMPLETE,6000000);

}

While the invention has been disclosed in connection with the preferred embodiments shown and described in detail, various modifications and improvements thereon will become readily apparent to those skilled in the art. For example, the device under test can be any device capable of processing packets. The device can include chips, subsystems and/or complete network traffic centers. The described exemplary headers can be adapted to other network protocols or customized for specific applications. Accordingly, the spirit and scope of the present invention is to be limited only by the following claims.

What is claimed is:

1. Method for verifying a device under test, comprising:
generating a packet descriptor,
assigning a unique packet identifier to said packet descriptor,
generating a packet corresponding to said packet descriptor, said packet having the unique packet identifier of said packet descriptor,
transmitting said packet to the device for processing by the device,
identifying said processed packet based on said unique packet identifier, and
comparing said processed packet with said generated packet having the same unique packet identifier to verify the device under test.

2. The method of claim 1, wherein generating a packet descriptor includes retrieving from a packet database a packet descriptor specified by a packet description language.

3. The method of claim 2, further including storing the unique packet identifier in a packet identifier database, wherein said packet descriptor can be retrieved from the packet database based on said unique packet identifier.

4. The method of claim 1, wherein said unique packet identifier is a frame sequence number.

5. The method of claim 1, wherein comparing said processed packet includes obtaining a copy of the packet descriptor having said unique packet identifier, expanding said copy into a regenerated packet, and comparing said processed packet with said regenerated packet.

6. The method of claim 1, wherein comparing said processed packet includes obtaining a copy of the packet descriptor having said unique packet identifier, modifying said obtained copy of the packet descriptor, generating a regenerated packet from said modified copy, and comparing said processed packet with said regenerated packet.

7. The method of claim 1, wherein generating a packet descriptor includes retrieving from a packet database a generalized packet descriptor adapted for a plurality of packet transmission protocols and retaining in the packet descriptor only those elements from the generalized packet descriptor that correspond to a desired packet transmission protocol.

8. The method of claim 1, further including forming a queue of packet descriptors, each packet descriptor having the corresponding unique packet identifier, wherein a sequence of packets corresponding to the packet descriptor queue is transmitted to the device.

9. The method of claim 1, further including
forming from a plurality of packet descriptors a flow representing a transmission rate of the packet descriptors, each flow having a unique flow identifier,
combining a plurality of the flows into a port queue, and
transmitting packets corresponding to the port queue to the device for processing by the device.

10. The method of claim 9, wherein combining includes one of aggregating and merging.

11. The method of claim 9, wherein the processed flows are de-multiplexed based on the unique flow identifier, before the processed packets are identified.

12. The method of claim 10, further including analyzing the de-multiplexed flows to provide a statistics of the flows.

13. The method of claim 1, wherein the device under test is a network device selected from the group consisting of switches and routers.

14. A system for verification of a device under test, comprising:
a packet database comprising packet descriptors, each packet descriptor having a unique packet identifier,
a transmit transactor coupled to the device and receiving said packet descriptor, said transmit transactor building from the packet descriptor a packet byte stream to be transmitted to the device for processing,
a receive transactor receiving from the device the processed byte stream and identifying the received packets based on the unique packet identifier, and
a packet checker comparing said identified packet with a packet expanded from a corresponding packet descriptor in the packet database having the same unique packet identifier.

15. The system of claim 14, further comprising a packet identifier database that stores said unique packet identifier, wherein said packet descriptor can be retrieved from the packet database based on said unique packet identifier.

16. The system of claim 14, wherein said unique packet identifier is a frame sequence number.

17. The system of claim 14, further comprising a packet descriptor builder that builds a queue of packet descriptors, each packet descriptor having the unique packet identifier, wherein a sequence of packets corresponding to the packet descriptor queue is transmitted to the device.

18. A computer program product for verifying a device under test, comprising:
computer executable code for generating a packet descriptor and assigning a unique packet identifier to said packet descriptor,
computer executable code for generating a packet corresponding to said packet descriptor, said packet having the unique packet identifier of said packet descriptor,
computer executable code for transmitting said packet to the device under test for processing by the device under test, and
computer executable code for identifying said processed packet based on said unique packet identifier and comparing said processed packet with said generated packet having the same unique packet identifier to verify the device under test.
